(19) United States
(12) Patent Application Publication
(10) Pub. No.: US 2005/0105292 A1
(43) Pub. Date: May 19, 2005

(54) Lamp shade

(76) Inventor: Kevin Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/714,989

(22) Filed: Nov. 17, 2003

(51) Int. Cl. F21V 1/06

(52) U.S. Cl. 362/352; 362/450

(57) ABSTRACT

A lamp shade includes a shade, and a support structure mounted in the shade for supporting the shade. The support structure includes a first ring fixed on a first end of the shade, a second ring fixed on a second end of the shade, and a plurality of support brackets detachably mounted between the first ring and the second ring. Thus, the lamp shade can be folded when not in use, so as to reduce the volume of the lamp shade, thereby facilitating package, storage and transportation of the lamp shade, and thereby decreasing the costs of transportation.

### BACKGROUND OF THE INVENTION

1. Field of the Invention

The present invention relates to a lamp shade, and more particularly to a lamp shade that can be folded when not in use, so as to reduce the volume of the lamp shade, thereby facilitating package, storage and transportation of the lamp shade, and thereby decreasing the costs of transportation.

2. Description of the Related Art

A conventional lamp shade 1 in accordance with the prior art shown in FIG. 5 comprises an upper ring 11, a lower ring 12, and a plurality of ribs 13 mounted between the upper ring 11 and the lower ring 12. The upper ring 11 has a mounting rack 111 for mounting a lamp, such as a table lamp.

However, the ribs 13 are fixed between the upper ring 11 and the lower ring 12 by soldering, so that the conventional lamp shade 1 has a fixed volume and cannot be folded, thereby causing inconvenience in package, storage and transportation of the conventional lamp shade 1, and thereby increasing costs of package and transportation.

### SUMMARY OF THE INVENTION

The primary objective of the present invention is to provide a lamp shade that can be folded when not in use, so as to reduce the volume of the lamp shade, thereby facilitating package, storage and transportation of the lamp shade, and thereby decreasing the costs of package and transportation.

Another objective of the present invention is to provide a lamp shade that can be assembled and disassembled easily and conveniently, thereby facilitating the user assembling and disassembling the lamp shade.

In accordance with the present invention, there is provided a lamp shade, comprising:
a shade; and
a support structure mounted in the shade for supporting the shade, the support structure including:
a first ring fixed on a first end of the shade;
a second ring fixed on a second end of the shade; and
a plurality of support brackets detachably mounted between the first ring and the second ring.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a lamp shade in accordance with the preferred embodiment of the present invention;

FIG. 2 is a plan cross-sectional view of the lamp shade as shown in FIG. 1;

FIG. 3 is a schematic plan assembly view showing the lamp shade being mounted on a table lamp; and

FIG. 4 is a perspective folded view of the lamp shade in accordance with the preferred embodiment of the present invention; and

FIG. 5 is a perspective view of a conventional lamp shade in accordance with the prior art.

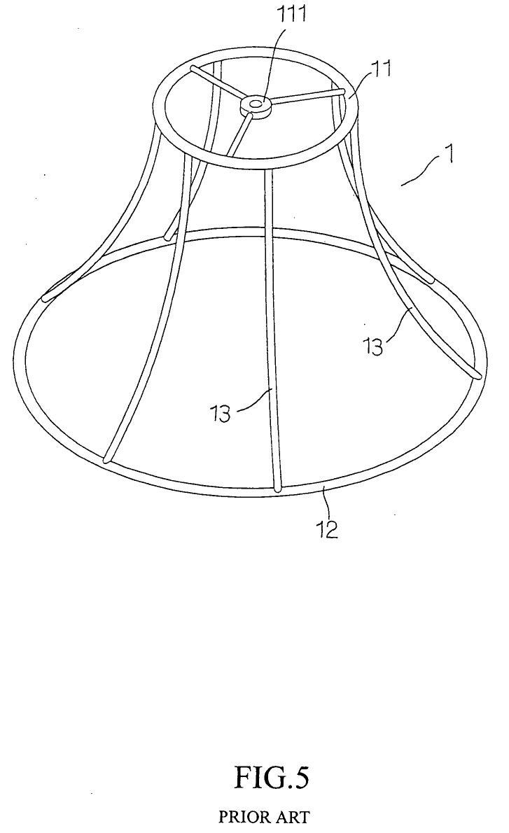

### DETAILED DESCRIPTION OF THE INVENTION

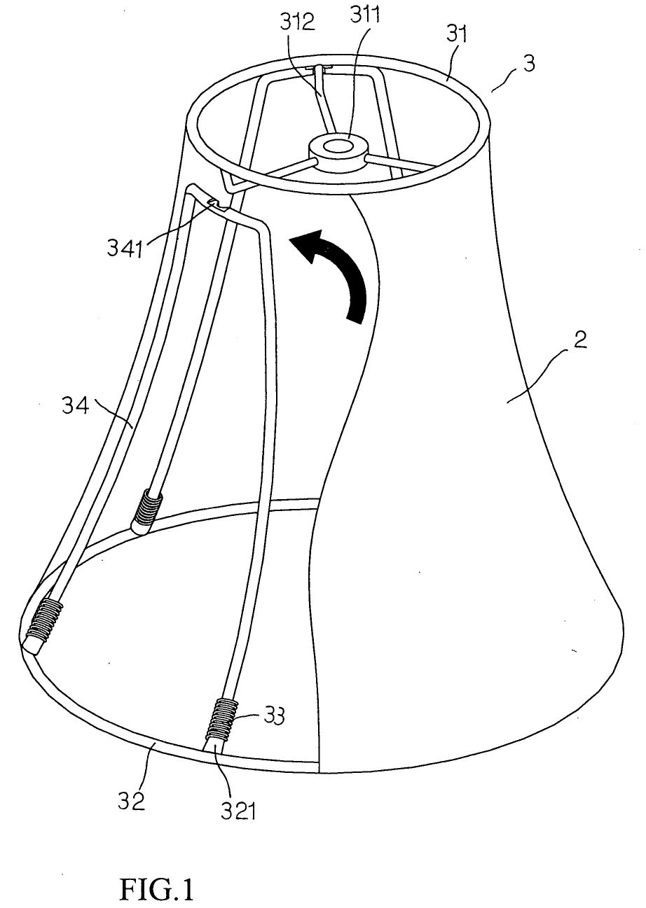

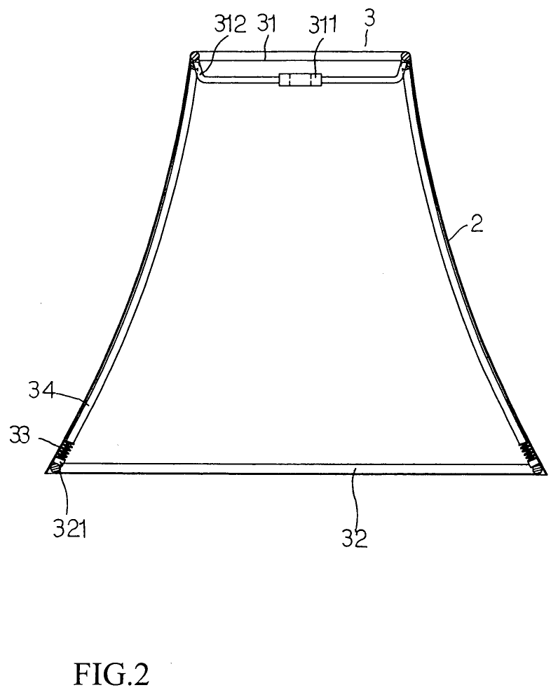

Referring to the drawings and initially to FIGS. 1 and 2, a lamp shade in accordance with the preferred embodiment of the present invention comprises a shade 2, and a support structure 3 mounted in the shade 2 for supporting the shade 2.

The shade 2 is made of flexible material, such as cloth or the like.

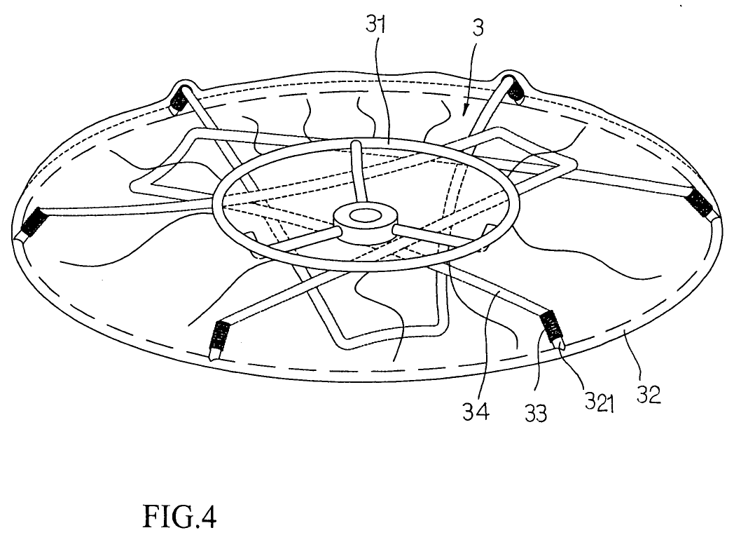

The support structure 3 is foldable as shown in FIG. 4 and includes a first ring 31 fixed on a first end of the shade 2, a second ring 32 fixed on a second end of the shade 2, and a plurality of support brackets 34 detachably mounted between the first ring 31 and the second ring 32.

The first ring 31 of the support structure 3 has a periphery provided with a plurality of substantially L-shaped support bars 312 and has a central portion provided with a support portion 32 supported by the support bars 312.

The second ring 32 of the support structure 3 has a periphery provided with a plurality of mounting studs 321.

Each of the support brackets 34 of the support structure 3 is substantially inverted U-shaped and has two ends each connected to a respective one of the mounting studs 321 of the second ring 32 by an elastic member 33.

Each of the support brackets 34 of the support structure 3 has a mediate portion detachably rested on a respective one of the support bars 312 of the first ring 31. Preferably, the mediate portion of each of the support brackets 34 is formed with a locking groove 341 for locking a respective one of the support bars 312 of the first ring 31. Each of the two ends of each of the support brackets 34 is extended outward from the mediate portion of each of the support brackets 34.

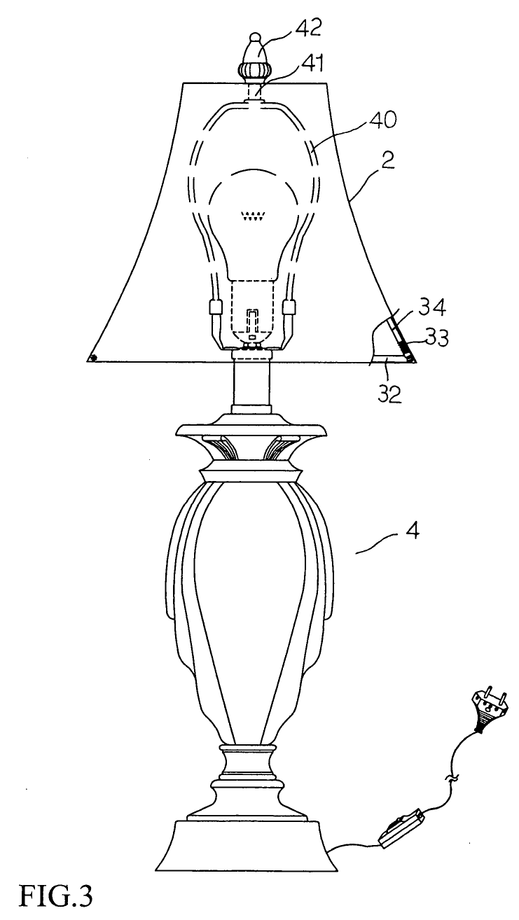

In assembly, referring to FIGS. 1-3, the first ring 31 is pulled upward to expand the shade 2. Then, each of the support brackets 34 is pulled outward until the locking groove 341 of each of the support brackets 34 is locked on a respective one of the support bars 312 of the first ring 31. At this time, each of the support brackets 34 is pushed upward by the elastic force of the elastic members 33, so that each of the support brackets 34 is closely urged between the first ring 31 and the second ring 32 so as to fully expand the shade 2, thereby forming an expanded lamp shade.

Subsequently, the expanded lamp shade is mounted on a table lamp 4. The table lamp 4 includes a harp 40 mounted in the shade 2 and rested on the bottom of the support portion 311 of the first ring 31, a threaded rod 41 mounted on the harp 40 and extended through the support portion 311 of the first ring 31, and a decorative nut 42 screwed on the threaded rod 41 and rested on the top of the support portion 311 of the first ring 31, so that the expanded lamp shade is mounted on the table lamp 4.

Alternatively, the decorative nut 42 is unscrewed from the threaded rod 41 to detach the support portion 311 of the first ring 31 from the threaded rod 41 of the harp 40, so that the expanded lamp shade can be removed from the table lamp 4.

Subsequently, each of the support brackets 34 is pressed inward to detach the locking groove 341 of each of the support brackets 34 from a respective one of the support bars 312 of the first ring 31 until each of the support brackets 34 is disposed at a horizontal state. Then, the first ring 31 is pressed downward to fold the shade 2 until the first ring 3I is rested on each of the support brackets 34, so that the lamp shade is fully folded as shown in FIG. 4.

Accordingly, the lamp shade is assembled and disassembled easily and conveniently, thereby facilitating the user assembling and disassembling the lamp shade. In addition, the lamp shade can be fully folded when not in use, so as to reduce the volume of the lamp shade, thereby facilitating package, storage and transportation of the lamp shade, and thereby decreasing costs of package and transportation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp shade, comprising:
a shade; and
a support structure mounted in the shade for supporting the shade, the support structure including:
a first ring fixed on a first end of the shade;
a second ring fixed on a second end of the shade; and
a plurality of support brackets detachably mounted between the first ring and the second ring.

2. The lamp shade in accordance with claim 1, wherein the shade is made of flexible material.

3. The lamp shade in accordance with claim 1, wherein the shade is made of cloth.

4. The lamp shade in accordance with claim 1, wherein the support structure is foldable.

5. The lamp shade in accordance with claim 1, wherein the first ring of the support structure has a periphery provided with a plurality of support bars, and each of the support brackets of the support structure has a mediate portion detachably rested on a respective one of the support bars of the first ring.

6. The lamp shade in accordance with claim 5, wherein the mediate portion of each of the support brackets is formed with a locking groove for locking a respective one of the support bars of the first ring.

7. The lamp shade in accordance with claim 5, wherein each of the support bars of the first ring is substantially L-shaped.

8. The lamp shade in accordance with claim 5, wherein the first ring of the support structure has a central portion provided with a support portion supported by the support bars.

9. The lamp shade in accordance with claim 1, wherein the second ring of the support structure has a periphery provided with a plurality of mounting studs, and each of the support brackets of the support structure has two ends each connected to a respective one of the mounting studs of the second ring by one of a plurality of elastic members.

10. The lamp shade in accordance with claim 9, wherein each of the two ends of each of the support brackets is extended outward from a mediate portion of each of the support brackets.

11. The lamp shade in accordance with claim 9, wherein each of the support brackets is urged between the first ring and the second ring by the elastic force of the elastic members.

12. The lamp shade in accordance with claim 1, wherein each of the support brackets of the support structure is substantially inverted U-shaped.
